(19) United States
(12) Patent Application Publication
(10) Pub. No.: US 2025/0132879 A1
(43) Pub. Date: Apr. 24, 2025

(54) REFERENCE SIGNAL DESIGNS

(71) Applicant: QUALCOMM Incorporated, San Diego, CA (US)

(72) Inventors: Runxin WANG, San Diego, CA (US); Muhammad Sayed Khairy ABDELGHAFFAR, San Jose, CA (US); Yu ZHANG, San Diego, CA (US)

(21) Appl. No.: 18/694,352

(22) PCT Filed: Dec. 1, 2021
(86) PCT No.: PCT/CN2021/134765

§ 371 Date: Mar. 21, 2024

(51) Int. Cl. H04L 5/00; H04W 72/044; H04W 72/232

(52) U.S. Cl. CPC H04L 5/0051; H04L 5/0053; H04W 72/044; H04W 72/232

(57) ABSTRACT

Methods, systems, and devices for wireless communications are described. A user equipment (UE) may receive control signaling indicating a plurality of port arrangements for transmitting one or more sounding reference signals to the base station. The UE may select a port arrangement of the plurality of port arrangements based on a first quantity of ports available to the UE for transmitting the one or more sounding reference signals. The UE may transmit a first sounding reference signal using a second quantity of ports of the first quantity of ports based on the selected port arrangement. Further, the UE may transmit a second sounding reference signal using a third quantity of ports of the first quantity of ports based on the selected port arrangement.

### CROSS REFERENCE

The present Application is a 371 national stage filing of International PCT Application No. PCT/CN2021/134765 by WANG et al. entitled “REFERENCE SIGNAL DESIGNS,” filed Dec. 1, 2021, which is assigned to the assignee hereof, and which is expressly incorporated by reference in its entirety herein.

### FIELD OF TECHNOLOGY

The following relates to wireless communications, including reference signal designs.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In the course of wireless communications, a UE may transmit a sounding reference signal using one or more antenna ports. However, approaches to transmitting sounding reference signals using multiple ports may be improved.

### SUMMARY

The described techniques relate to improved methods, systems, devices, and apparatuses that support reference signal designs. Generally, the described techniques provide for transmitting sounding reference signals using multiple ports (e.g., three ports) and associated considerations. A user equipment (UE) may receive control signaling indicating a plurality of port arrangements for transmitting one or more sounding reference signals to the base station. The UE may select a port arrangement of the plurality of port arrangements based on a first quantity of ports available to the UE for transmitting the one or more sounding reference signals. The UE may transmit a first sounding reference signal using a second quantity of ports of the first quantity of ports based on the selected port arrangement. Further, the UE may transmit a second sounding reference signal using a third quantity of ports of the first quantity of ports based on the selected port arrangement.

A method for wireless communications at a user equipment (UE) is described. The method may include receiving, from a base station, control signaling indicating a set of multiple port arrangements for transmitting one or more sounding reference signals to the base station, selecting a port arrangement of the set of multiple port arrangements based on a first quantity of ports available to the UE for transmitting the one or more sounding reference signals, transmitting a first sounding reference signal using a second quantity of ports of the first quantity of ports based on the selected port arrangement, and transmitting a second sounding reference signal using a third quantity of ports of the first quantity of ports based on the selected port arrangement.

An apparatus for wireless communications at a UE is described. The apparatus may include a processor, memory coupled with the processor, and instructions stored in the memory. The instructions may be executable by the processor to cause the apparatus to receive, from a base station, control signaling indicating a set of multiple port arrangements for transmitting one or more sounding reference signals to the base station, select a port arrangement of the set of multiple port arrangements based on a first quantity of ports available to the UE for transmitting the one or more sounding reference signals, transmit a first sounding reference signal using a second quantity of ports of the first quantity of ports based on the selected port arrangement, and transmit a second sounding reference signal using a third quantity of ports of the first quantity of ports based on the selected port arrangement.

Another apparatus for wireless communications at a UE is described. The apparatus may include means for receiving, from a base station, control signaling indicating a set of multiple port arrangements for transmitting one or more sounding reference signals to the base station, means for selecting a port arrangement of the set of multiple port arrangements based on a first quantity of ports available to the UE for transmitting the one or more sounding reference signals, means for transmitting a first sounding reference signal using a second quantity of ports of the first quantity of ports based on the selected port arrangement, and means for transmitting a second sounding reference signal using a third quantity of ports of the first quantity of ports based on the selected port arrangement.

A non-transitory computer-readable medium storing code for wireless communications at a UE is described. The code may include instructions executable by a processor to receive, from a base station, control signaling indicating a set of multiple port arrangements for transmitting one or more sounding reference signals to the base station, select a port arrangement of the set of multiple port arrangements based on a first quantity of ports available to the UE for transmitting the one or more sounding reference signals, transmit a first sounding reference signal using a second quantity of ports of the first quantity of ports based on the selected port arrangement, and transmit a second sounding reference signal using a third quantity of ports of the first quantity of ports based on the selected port arrangement.

Some examples of the method, apparatuses, and non-transitory computer-readable medium described herein may further include operations, features, means, or instructions for transmitting a third sounding reference signal using a fourth quantity of ports of the first quantity of ports based on the selected port arrangement.

Some examples of the method, apparatuses, and non-transitory computer-readable medium described herein may further include operations, features, means, or instructions for transmitting a fourth sounding reference signal using a fifth quantity of ports of the first quantity of ports based on the selected port arrangement.

Some examples of the method, apparatuses, and non-transitory computer-readable medium described herein may further include operations, features, means, or instructions for transmitting the first sounding reference signal in a first time resource and the second sounding reference signal in a second time resource, where the first time resource and the second time resource may be separated by a third time resource.

Some examples of the method, apparatuses, and non-transitory computer-readable medium described herein may further include operations, features, means, or instructions for transmitting the first sounding reference signal in a first time resource and the second sounding reference signal in a second time resource, where the first time resource and the second time resource may be contiguous.

Some examples of the method, apparatuses, and non-transitory computer-readable medium described herein may further include operations, features, means, or instructions for selecting one or more cyclic shift indices based on a rounding function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal may be based on the selected one or more cyclic shift indices.

Some examples of the method, apparatuses, and non-transitory computer-readable medium described herein may further include operations, features, means, or instructions for selecting one or more cyclic shift indices based on a floor function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal may be based on the selected one or more cyclic shift indices.

Some examples of the method, apparatuses, and non-transitory computer-readable medium described herein may further include operations, features, means, or instructions for selecting one or more cyclic shift indices based on a ceiling function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal may be based on the selected one or more cyclic shift indices.

Some examples of the method, apparatuses, and non-transitory computer-readable medium described herein may further include operations, features, means, or instructions for transmitting a first indication of a port arrangement capability of the UE, where the port arrangement capability includes a second indication of the first quantity of ports.

Some examples of the method, apparatuses, and non-transitory computer-readable medium described herein may further include operations, features, means, or instructions for mapping the second quantity of ports to a first pattern of frequency resources for communicating sounding reference signals, calculating a cyclic shift for each port of the second quantity of ports, mapping the third quantity of ports to a second pattern of frequency resources for communicating the sounding reference signals, and calculating a cyclic shift for each port of the third quantity of ports.

Some examples of the method, apparatuses, and non-transitory computer-readable medium described herein may further include operations, features, means, or instructions for mapping a first portion of the second quantity of ports to a first pattern of frequency resources for communicating sounding reference signals and a second portion of the second quantity of ports to a second pattern of frequency resources for communicating the sounding reference signals, calculating a cyclic shift for each port of the second quantity of ports, mapping a first portion of the third quantity of ports to a third pattern of frequency resources for communicating the sounding reference signals and a second portion of the third quantity of ports to a fourth pattern of frequency resources for communicating the sounding reference signals, and calculating a cyclic shift for each port of the third quantity of ports.

Some examples of the method, apparatuses, and non-transitory computer-readable medium described herein may further include operations, features, means, or instructions for identifying the first quantity of ports available to the UE for transmitting the one or more sounding reference signals, where selecting the port arrangement may be based on identifying the first quantity of ports.

In some examples of the method, apparatuses, and non-transitory computer-readable medium described herein, the second quantity of ports and the third quantity of ports may be a same quantity.

In some examples of the method, apparatuses, and non-transitory computer-readable medium described herein, the second quantity of ports and the third quantity of ports may be different quantities.

In some examples of the method, apparatuses, and non-transitory computer-readable medium described herein, one or more ports of the second quantity of ports may be also included in the third quantity of ports.

### BRIEF DESCRIPTION OF THE DRAWINGS

FIG. 1 illustrates an example of a wireless communications system that supports reference signal designs in accordance with examples as disclosed herein.

FIG. 2 illustrates an example of a wireless communications system that supports reference signal designs in accordance with examples as disclosed herein.

FIG. 3 illustrates examples of sound reference signal (SRS) transmission scheme that supports reference signal designs in accordance with examples as disclosed herein.

FIG. 4 illustrates examples of SRS transmission scheme that supports reference signal designs in accordance with examples as disclosed herein.

FIG. 5 illustrates examples of SRS transmission scheme that supports reference signal designs in accordance with examples as disclosed herein.

FIG. 6 illustrates examples of SRS transmission scheme that supports reference signal designs in accordance with examples as disclosed herein.

FIG. 7 illustrates an example of a process flow that supports reference signal designs in accordance with examples as disclosed herein.

FIGS. 8 and 9 show block diagrams of devices that support reference signal designs in accordance with examples as disclosed herein.

FIG. 10 shows a block diagram of a communications manager that supports reference signal designs in accordance with examples as disclosed herein.

FIG. 11 shows a diagram of a system including a device that supports reference signal designs in accordance with examples as disclosed herein.

FIGS. 12 through 15 show flowcharts illustrating methods that support reference signal designs in accordance with examples as disclosed herein.

### DETAILED DESCRIPTION

In the course of wireless communications, a user equipment (UE) may transmit sounding reference signals (SRSs) to a base station so that the base station may measure the uplink channel quality and make determinations based on that channel quality accordingly (e.g., adjust scheduling, configurations, transmission parameters, or other parameters). In some scenarios, the base station may rely on reciprocity between the uplink and the downlink to estimate downlink channel state information based on a measurement of uplink channel state information. For example, a UE may transmit an SRS to the base station to perform uplink channel measurements, and the base station may estimate downlink channel state information based on the uplink channel measurements. However, the number of antennas used at a UE transmit uplink may be different than the number of antennas used by the base station to transmit downlink. The differences between base stations and UEs may make determinations based on reciprocity between uplink and downlink less reliable. In some such scenarios, SRS switching (e.g., transmitting SRSs through different antenna ports) may be used to obtain measurements that may include all of the antennas (e.g., antennas used for reception that may not be used for transmission). However, in some such antenna switching schemes, a subset antenna configurations may be supported (e.g., due to approaches used for cyclic shift calculations), and these schemes may be improved.

To improve such antenna switching schemes and reciprocity between uplink and downlink, a UE may transmit SRSs using various quantities of transmit antenna ports, SRS resources, and total quantities of antenna ports. For example, a UE may, based on one or more UE capabilities, select a port arrangement (e.g., from a plurality of port arrangements available to the UE) to use for transmitting SRSs. Such an arrangement may include a number of antenna ports used for transmission (e.g., 3 antenna ports or other numbers of transmit antenna ports), a number of different SRSs transmitted over a number of SRS resources, and a total number of antenna ports at the UE (e.g., 2, 3, 4, 6, 8, or other numbers). In this way, the UE may transmit SRSs that may provide measurements associated with uplink transmissions from some or all of the antenna ports available at the UE, and a base station may further make estimations of downlink channel conditions based on such measurements. In addition, a UE may make one or more calculations associated with cyclic shifts that may accommodate such antenna switching schemes with differing numbers of transmit antenna ports, total number of antenna ports, and SRS resources. The UE may multiplex one or more antenna ports, and may map such ports to one or more transmission combs, and may further transmit the SRSs using one or more cyclic shifts. The UE may also transmit one or more indications of antenna switching scheme capabilities (e.g., particular combinations of transmit antenna ports, SRS resources, numbers of total antenna ports, the use of guard symbols, the use of no guard symbols (e.g., contiguous resources in at least one domain), or any combination thereof).

Aspects of the disclosure are initially described in the context of wireless communications systems. Aspects of the disclosure are then described in the context of an wireless communication system, various examples of SRS transmission schemes, and a process flow. Aspects of the disclosure are further illustrated by and described with reference to apparatus diagrams, system diagrams, and flowcharts that relate to reference signal designs.

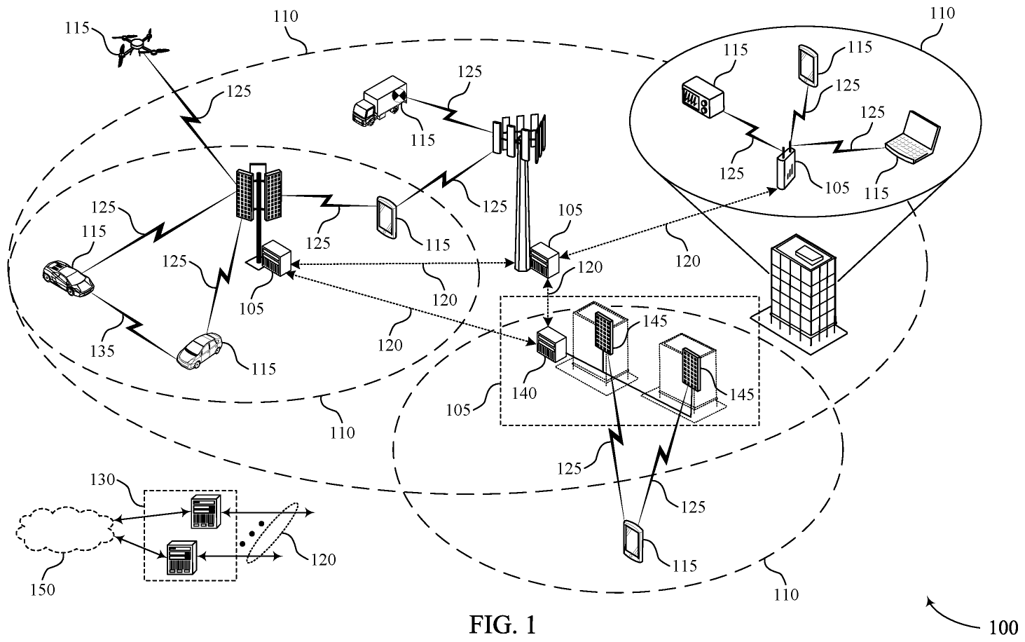

FIG. 1 illustrates an example of a wireless communications system 100 that supports reference signal designs in accordance with examples as disclosed herein. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive control signaling (e.g., from the base station 105) that may indicate one or more possible port arrangements for transmitting one or more SRSs. The UE 115 may select a port arrangement of those received from the base station 105 based on one or more factors. For example, such a port arrangement may be a software configuration of antenna ports that may be used for receiving one or more downlink transmissions and transmitting one or more SRSs. Further, a port arrangement may indicate or include a number or quantity of ports (e.g., 2, 3, 4, or another quantity) used for transmission (e.g., of SRSs), a total number or quantity of antenna ports at the UE (e.g., a number or quantity of ports used to receive one or more signals). Based on the selected port arrangement, the UE 115 may transmit multiple SRSs (e.g., to the base station 105) so that another device may perform measurements based on the SRSs. In some examples, these various port arrangement may include different numbers or quantities of transmission ports and reception ports, offering flexibility in SRS transmission approaches. Further, calculation of cyclic shifts may be selected, configured, or adjusted to accommodate some numbers or quantities of transmission ports, reception ports, or both, by applying one or more functions (e.g., rounding, floor, ceiling, or other functions) to one or more cyclic shift parameters.

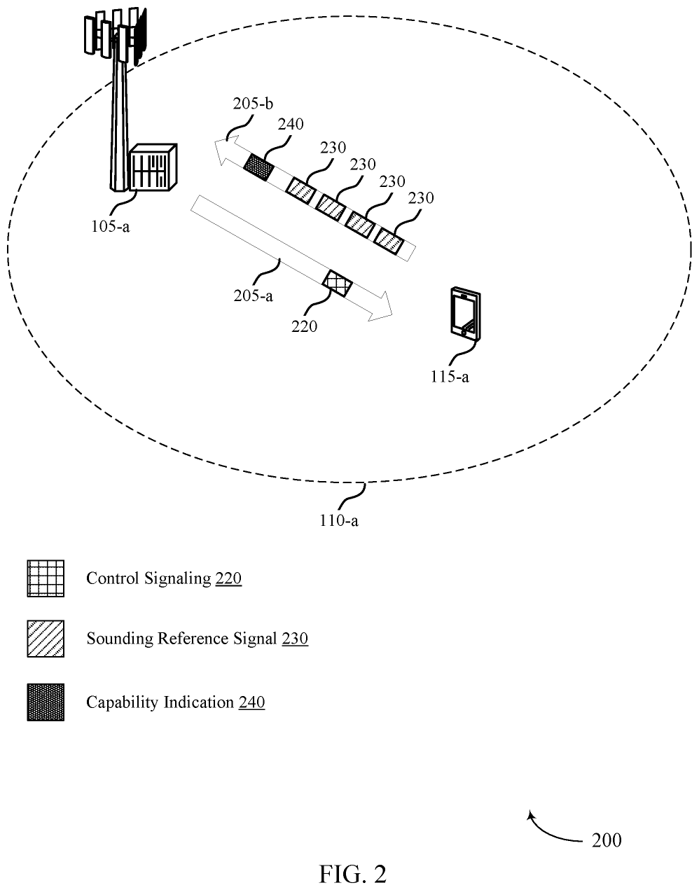

FIG. 2 illustrates an example of a wireless communications system 200 that supports reference signal designs in accordance with examples as disclosed herein. The wireless communications system 200 may include a base station 105-a that may be an example of the base station 105 discussed in relation to FIG. 1. The wireless communications system 200 may include UE 115-a that may be an example of UE 115 discussed in relation to FIG. 1. In some examples, the base station 105-a and the UE 115 a may be located in a geographic coverage area 110-a. The base station 105-a and UE 115-a may communicate via one or more downlink communication links 205-a and one or more uplink communication links 205-b. The UE 115-a may receive control signaling 220 (e.g., from the base station 105-a) in accordance with the approaches described herein. The UE 115-a may transmit the SRS 230 (e.g., one or more of SRS 230) in accordance with the approaches described herein.

The UE 115-a may transmit the SRSs 230 to the base station 105-a station so that the base station may measure the uplink channel quality and make determinations based on that channel quality accordingly (e.g., adjust scheduling, configurations, transmission parameters, or other parameters). Further, in some scenarios, reciprocity may be used to estimate downlink channel state information based on a measurement of uplink channel state information. For example, the base station 105-a may estimate one or more elements of downlink channel state information based on one or more indications of uplink channel state information. An SRS (e.g., SRS 230) may be one example of such uplink channel station information. However, in some examples, a number or quantity of antennas of the UE 115-a used for uplink communications may be different than a number or quantity of antenna used for downlink communications. In some examples, the UE 115-a may engage in SRS switching, in which the UE 115-a may transmit the SRS 230 using multiple antenna ports. In this way, uplink channel state information may be obtained at the base station 105-a so that downlink channel state information may be obtained (e.g., through reciprocity) that may account for or be associated with all of the antennas of the UE 115-a.

In some examples, the UE 115-a may be configured with multiple SRS resources sets for antenna switching. For example, the UE 115-a may transmit two SRSs 230 using two SRS resources and three transmit ports. In some examples, a first resource set may include two resources. In other examples, a first resource set and a second resource set may include one resource each. In some examples involving two resource sets, the UE 115-a may transmit the SRSs 230 using three antenna ports for each of the two resource sets, and two SRSs 230 may be transmitted.

The UE 115-a may receive (e.g., from the base station 105-a) control signaling 220 that may indicate multiple port arrangements for SRS transmission. As used herein, a port arrangement may refer to an arrangement (e.g., a software arrangement) of one or more ports used for one or more antennas of a device (e.g., a user equipment). A port arrangement may describe a number or quantity of ports used for transmission, reception, or both, of one or more signals, such as SRSs 230, downlink signals, control signaling 220, other signals, or any combination thereof. Further, the port arrangement may describe a number or quantity of ports used for transmission of one or more signals per resource. For example, a port arrangement may describe that 3 antenna ports are used for transmission of SRSs 230, and that 6 antenna ports are used for reception of signals (e.g., downlink transmissions from the base station 105-a). Such a port arrangement may be referred to as a “3T6R” port arrangement. More generally, such a port arrangement or antenna switching combination may be formatted as or referred to as an xTyR port arrangement or an xTyR antenna switching combination, where x indicates a number or quantity of transmit antenna ports, and y indicates a number or quantity of receive antenna ports. For example, the UE 115-a, the base station 105-a, or both, may utilize one or more port arrangements referred to as 3T4R, 3T3R, 2T4R, 2T2R, 1T4R, 1T2R, 1T1R, 3T6R, 3T4R, 2T6R, 2T4R, 2T2R, 1T6R, 1T4R 1T2R, 1T1R, 3T8R, 3T6R, 3T4R, 2T8R, 2T6R, 2T4R, 2T2R, 1T8R, 1T6R, 1T4R, 1T2R, 1T1R, a subset of one or more of the preceding, or any combination thereof. As such, the UE 115-a, the base station 105-a, one or more other devices, or any combination thereof may utilize various port arrangements or antenna switching combinations. Other combinations of transmission and reception antenna port numbers or quantities, port arrangements, antenna switching combinations, or any combination thereof, are possible and are contemplated by the subject matter discussed herein.

In accordance with the approaches described herein, UE 115-a may transmit multiple SRSs 230 to the base station 105-a in a slot, and a waiting or guard period lasting a number or quantity of symbols may be placed in between the multiple SRSs 230. In some examples, the number or quantity of symbols of the waiting or guard period may be 2 (e.g., for 120 kHz subcarrier spacing), 1 for one or more other cases, or another number or quantity). In some examples, during such a waiting or guard period, the UE 115-a may not transmit any other signal.

The UE 115-a may further employ the use of cyclic shifts in an SRS transmission scheme. For example, the UE 115-a may transmit the SRSs 230 using a cyclic shift for each SRS 230. In some examples, the use of a cyclic shift may be calculated using an equation that may include one or more parameters associated with a cyclic shift (e.g., a quantity of ports, a quantity of sounding reference signal resource sets, an upper limit for a quantity of sounding reference signal resources sets, a port index, or any combination thereof) such as Equation 1.

$${α}_{i} = 2 π \frac{{n}_{SRS}^{cs , i}}{{n}_{SRS}^{cs , max}} , ( {n}_{SRS}^{cs} + \frac{{n}_{SRS}^{cs , max} ( {p}_{i} - 1000 )}{{N}_{ap}^{SRS}} ) mod {n}_{SRS}^{cs , max} \qquad ( 1 )$$

Further, the UE 115-a may employ one or more patterns of frequency resources (e.g., transmission combs) for transmission of the SRSs 230. For example, the UE 115-a may transmit the SRSs 230 using a transmission comb or pattern based on a transmission comb number (e.g., K_{TC}) which may be associated with or contained in a parameter (e.g., a higher layer parameter, of which one example may be the transmissionComb parameter). Additionally or alternatively, one or more other parameters (e.g., n_{SRS}^{cs}∈0, 1, . . . , n_{SRS}^{cs,max}−1) may also be associated with or contained in such a parameter (e.g., a higher layer parameter, of which one example may be the transmissionComb parameter).

The UE 115-a may further employ multiplexing (e.g., code division multiplexing) in the course of engaging in an SRS transmission scheme. For example, the UE 115-a may code division multiplex multiple antenna ports (e.g., three antenna ports) and may further map the multiple antenna ports to a single pattern of frequency resources (e.g., a single transmission comb). In some examples, though multiple antenna ports may be mapped to a single pattern of frequency resources, one or more of the multiple antenna ports (or an SRS 230 transmitted using one or more of the multiple antenna ports) may be associated with unique cyclic shifts for transmission of the SRSs 230. Additionally or alternatively, the UE 115-a may code division multiplex some antenna ports (e.g., two antenna ports) and may not code division multiplex other ports (or may code division the other ports separately). For example, the UE 115-a may map the two antenna ports to a single first pattern of frequency resources (e.g., a single transmission comb), and may map a third antenna port to a second pattern of frequency resources (e.g., a second single transmission comb). Various combinations of code division multiplexing, mapping to patterns of frequency resources (e.g., transmission combs), cyclic shift calculation, and other procedures are possible, and are contemplated by the subject matter disclosed herein.

In some examples, the calculation of cyclic shifts (e.g., represented by αᵢ) may not be evenly divisible for one or more patterns of frequency resources (e.g., transmission combs). For example, if a comb number (e.g., K_{TC}) is 2, a corresponding value for a maximum number of cyclic shifts (e.g., n_{SRS}^{cs,max}) may be 8. Thus, given a number of antenna ports (e.g., Nₐₚ^{SRS}) of 3, one or more portions of equations (e.g., Equation 1 herein) used for cyclic shift calculation may not divide evenly into whole numbers.

Therefore, one or more functions (e.g., rounding functions, floor functions, ceiling functions, other functions, or any combination thereof) may be applied to one or more cyclic shift calculations to resolve issues of uneven division in some cyclic shift calculations. For example, in Equation 2, a rounding function is applied to various cyclic shift parameters.

$${α}_{i} = 2 π \frac{{n}_{SRS}^{cs , i}}{{n}_{SRS}^{cs , max}} , ( round ( {n}_{SRS}^{cs} + \frac{{n}_{SRS}^{cs , max} ( {p}_{i} - 1000 )}{{N}_{ap}^{SRS}} ) ) mod {n}_{SRS}^{cs , max} \qquad ( 2 )$$

Equation 3 demonstrates another option for the use of a rounding function on cyclic shift parameters.

$${α}_{i} = 2 π \frac{{n}_{SRS}^{cs , i}}{{n}_{SRS}^{cs , max}} , ( {n}_{SRS}^{cs} + round ( \frac{{n}_{cs , max}^{SRS}}{{N}_{ap}^{SRS}} ) ( {p}_{i} - 1000 ) ) mod {n}_{SRS}^{cs , max} \qquad ( 3 )$$

Equation 4 and Equation 5 demonstrate examples of the use of a floor function applied to cyclic shift parameters.

$${α}_{i} = 2 π \frac{{n}_{SRS}^{cs , i}}{{n}_{SRS}^{cs , max}} , ( {n}_{SRS}^{cs} + ⌊ \frac{{n}_{cs , max}^{SRS}}{{N}_{ap}^{SRS}} ⌋ ( {p}_{i} - 1000 ) ) mod {n}_{SRS}^{cs , max} \qquad ( 4 )$$

$${α}_{i} = 2 π \frac{{n}_{SRS}^{cs , i}}{{n}_{SRS}^{cs , max}} , ( {n}_{SRS}^{cs} + ⌊ \frac{{n}_{cs , max}^{SRS}}{{N}_{ap}^{SRS}} ( {p}_{i} - 10 \; 00 ) ⌋ ) mod {n}_{SRS}^{cs , max} \qquad ( 5 )$$

Equations 6 and 7 demonstrate examples of the use of a ceiling function applied to cyclic shift parameters.

$${α}_{i} = 2 π \frac{{n}_{SRS}^{cs , i}}{{n}_{SRS}^{cs , max}} , ( {n}_{SRS}^{cs} + ⌈ \frac{{n}_{cs , max}^{SRS}}{{N}_{ap}^{SRS}} ( {p}_{i} - 1000 ) ⌉ ) mod {n}_{SRS}^{cs , max} \qquad ( 6 )$$

$${α}_{i} = 2 π \frac{{n}_{SRS}^{cs , i}}{{n}_{SRS}^{cs , max}} , ( {n}_{SRS}^{cs} + ⌈ \frac{{n}_{cs , max}^{SRS}}{{N}_{ap}^{SRS}} ⌉ ( {p}_{i} - 1000 ) ) mod {n}_{SRS}^{cs , max} \qquad ( 7 )$$

In some examples, the UE 115-a may utilize three transmit antenna ports (e.g., Nₐₚ^{SRS}=3), and may further utilize a value of 4 for a cyclic shift calculation parameter (e.g., Nₐₚ^{SRS}′=4) to calculate one or more cyclic shifts for SRSs 230. Such an approach may utilize an equation such as Equation 8.

$${n}_{SRS}^{cs , i} = ( {n}_{SRS}^{cs} + \frac{{n}_{SRS}^{cs , max} ( {p}_{i} - 1000 )}{4} ) mod {n}_{SRS}^{cs , max} \qquad ( 8 )$$

In the approaches described herein, the use of calculations as discussed herein may not alter results when divisible values are used. As such, the approaches herein may be used for many cases of cyclic shift determination or calculation, and may not be limited to the particular examples described herein (e.g., the examples of three antenna ports per resource).

As can be seen by the examples provided herein, many options or combinations of functions (e.g., rounding, floor, ceiling, other functions, or any combination thereof), parameters (e.g., cyclic shift parameters), equations, port arrangements, and other elements are possible. Further, such combinations are contemplated by the subject matter discussed herein, and such subject matter is not limited to the particular examples discussed or featured herein.

In some examples, the UE 115-a may transmit (e.g., to the base station 105-a) a capability indication 240 or multiple capability indications 240. Such capability indications 240 may indicate one or more capabilities of the UE (e.g., UE 115-a) transmitting the capability indication 240. For example, the UE 115-a may transmit the capability indication 240 that may indicate one or more antenna switching combinations or port arrangements of which the UE 115-a is capable. For example, the UE 115-a may indicate that it is capable of a port arrangement that may include a number or quantity of transmit antenna ports and a second number or quantity of receive antenna ports. A capability indication 240 carrying or indicating such a port arrangement or antenna switching combination may include 3T4R, 3T3R, 2T4R, 2T2R, 1T4R, 1T2R, 1T1R, 3T6R, 3T4R, 2T6R, 2T4R, 2T2R, 1T6R, 1T4R 1T2R, 1T1R, 3T8R, 3T6R, 3T4R, 2T8R, 2T6R, 2T4R, 2T2R, 1T8R, 1T6R, 1T4R, 1T2R, 1T1R, a subset of one or more of the preceding, or any combination thereof.

In some examples, the UE 115-a may transmit to the base station 105-a (e.g., in the capability indication 240) an indication of support for the use of one or more guard symbols in connection with transmission of the SRSs 230. Additionally or alternatively, the UE 115-a may include an indication that the UE 115-a supports the transmission of multiple SRSs 230 without the use of a guard symbol (e.g., contiguous resources in at least one domain) and such an approach may be used for “fallback” SRS antenna switching. For example, if a UE 115-a supports a 3T6R port arrangement or antenna switching combination, the UE 115-a may indicate that the UE 115-a may support transmission of multiple SRSs 230 without the use of a guard symbol (e.g., for a 2P+1P configuration).

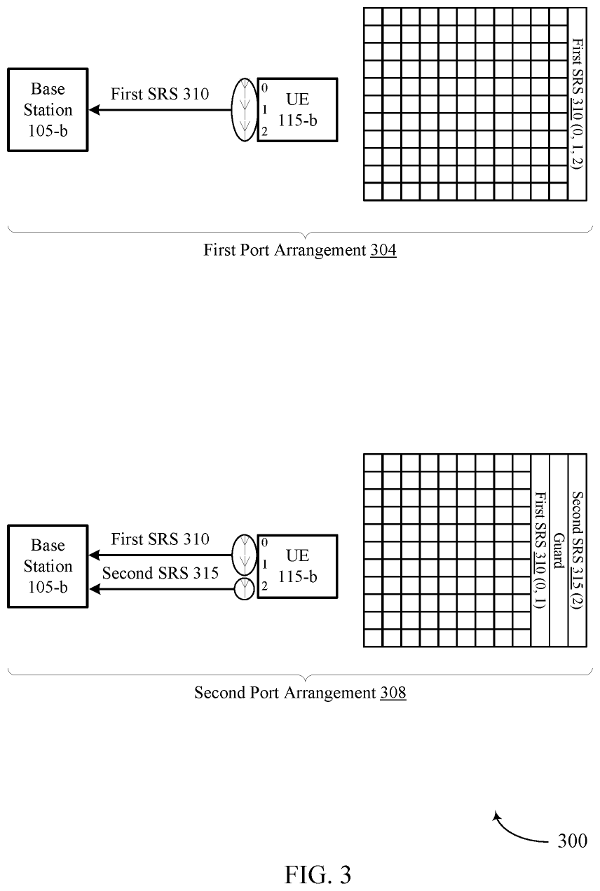

FIG. 3 illustrates examples of SRS transmission scheme 300 that supports reference signal designs in accordance with examples as disclosed herein. The SRS transmission scheme 300 may include a first port arrangement 304 and a second port arrangement 308. Though particular examples of port arrangements, SRS resources, SRS transmissions, ports, guard symbols, and other elements are shown in these examples, other combinations are possible and are contemplated by the subject matter disclosed herein.

In the first port arrangement 304, the UE 115-b may transmit the first SRS 310 and the second SRS 315 to the base station 105-b using a single SRS resource that may use three transmit antenna ports (e.g., 0, 1, and 2). The first SRS 310 may be associated with or transmitted using or transmitted using three antenna ports (e.g., 0, 1, and 2).

In the second port arrangement 308, the UE 115-b may transmit the first SRS 310 and the second SRS 315 to the base station 105-b using two SRS resources, which may be separated by a one or more guard symbols (e.g., as depicted). The first SRS 310 may be associated with two antenna ports (e.g., 0 and 1) and the second SRS 315 may be associated with one antenna port (e.g., 2). The second port arrangement 308 may include one resource set with two resources, or may include two resource sets each with one resource. In some examples, the transmission power of one or more ports may be different. This may cause the SRS channel estimation accuracy for each port to vary accordingly. Further, in some examples, the UE 115-b may transmit two resources simultaneously in different resource elements (e.g., which may involve the use of frequency domain multiplexing).

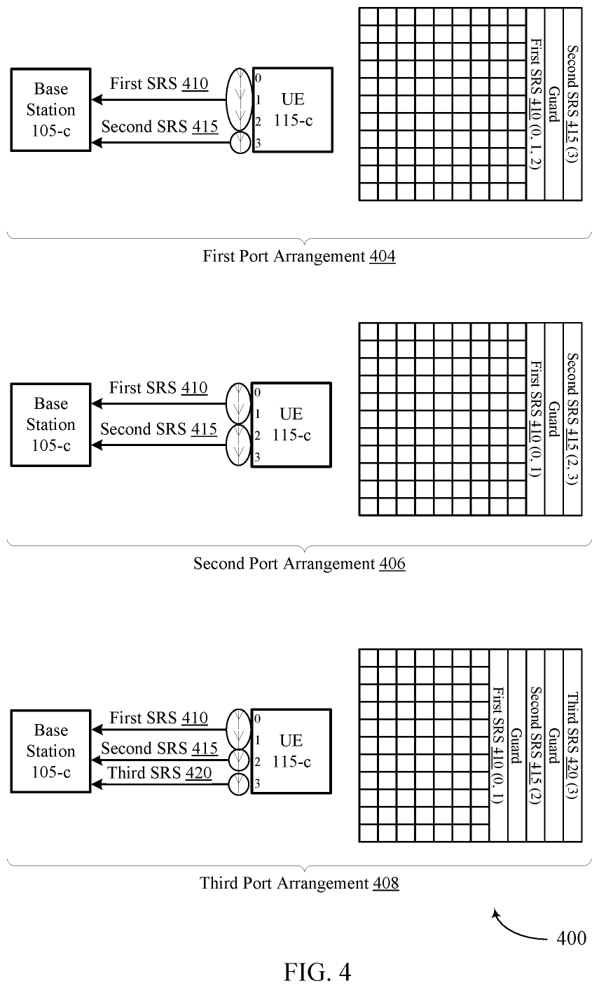

FIG. 4 illustrates examples of SRS transmission scheme 400 that supports reference signal designs in accordance with examples as disclosed herein. The SRS transmission scheme 400 may include a first port arrangement 404, a second port arrangement 406, and a third port arrangement 408. Though particular examples of port arrangements, SRS resources, SRS transmissions, ports, guard symbols, and other elements are shown in these examples, other combinations are possible and are contemplated by the subject matter disclosed herein.

In the first port arrangement 404, the UE 115-c may transmit the first SRS 410 and the second SRS 415 to the base station 105-c using two SRS resources that may use four transmit antenna ports (e.g., 0, 1, 2, and 3) and the two SRS resources may be separated by one or more guard symbols (e.g., as depicted). The first SRS 410 may be associated with or transmitted using three antenna ports (e.g., 0, 1, and 2) and the second SRS 415 may be associated with or transmitted using one antenna port (e.g., 3).

The first port arrangement 404 may include or be associated with two SRS resources mapped to a single resource set. Additionally or alternatively, a first SRS resource set may include a single resource associated with three antenna ports and the second SRS resource set may include a single resource associated with a single port. In some examples involving periodic/semi-persistent SRS, a single SRS resource set may include or be associated with two SRS resources. Further, the base station 105-c may configure one or more resource sets for situations involving periodic/semi-persistent SRS.

In some examples, a transmission power of one or more ports may be different than a transmission power of one or more other ports. For example, the transmission power of the first SRS 410 may be different from the transmission power of the second SRS 415. This may cause the SRS channel estimation accuracy for one or more ports to vary accordingly. Further, in some examples, the UE 115-c may transmit two resources simultaneously in different resource elements (e.g., which may involve the use of frequency domain multiplexing).

In the second port arrangement 406, the UE 115-c may transmit the first SRS 410 and the second SRS 415 to the base station 105-c using two SRS resources that may use four transmit antenna ports (e.g., 0, 1, 2, and 3) and the two SRS resources may be separated by a one or more guard symbols (e.g., as depicted). The first SRS 410 may be associated with or transmitted using two antenna ports (e.g., 0 and 1) and the second SRS 415 may be associated with or transmitted using two antenna ports (e.g., 2 and 3).

The second port arrangement 406 may include or be associated with two SRS resources mapped to a single resource set. Additionally or alternatively, a first SRS resource set may include a single resource associated with two antenna ports and the second SRS resource set may include a single resource associated two antenna ports. In some examples involving periodic/semi-persistent SRS, a single SRS resource set may include or be associated with two SRS resources. Further, the base station 105-c may configure one or more resource sets for situations involving periodic/semi-persistent SRS.

In some examples involving the second port arrangement 406, the UE 115-c may be capable of using three antenna ports for transmitting the first SRS 410 or the second SRS 415, but may utilize two antenna ports for each. Further, in some examples, the UE 115-c may transmit two resources simultaneously in different resource elements (e.g., which may involve the use of frequency domain multiplexing).

In the third port arrangement 408, the UE 115-c may transmit the first SRS 410, the second SRS 415, and the third SRS 420 to the base station 105-c using three SRS resources that may use four transmit antenna ports (e.g., 0, 1, 2, and 3) and the three SRS resources may be separated by a one or more guard symbols (e.g., as depicted). The first SRS 410 may be associated with or transmitted using two antenna ports (e.g., 0 and 1), the second SRS 415 may be associated with or transmitted using one antenna port (e.g., 2), and the third SRS 420 may be associated with or transmitted using one antenna port (e.g., 3).

The third port arrangement 408 may include or be associated with three SRS resources mapped to a single resource set. Additionally or alternatively, a first SRS resource set may include a single resource associated with two antenna ports and the second SRS resource set may include two resources associated with one antenna port each. Additionally or alternatively, each of a first SRS resource set, a second SRS resource set, and a third SRS resource set may include a single SRS resource, and one such SRS resource may be associated with two antenna ports, while the two remaining SRS resources may be associated with a single antenna port each.

In some examples, a transmission power of one or more ports may be different than a transmission power of one or more other ports. For example, the transmission power of the first SRS 410 may be different from the transmission power of the second SRS 415 which may also be different from the transmission power of the third SRS 420. This may cause the SRS channel estimation accuracy for one or more ports to vary accordingly. In some examples, the UE 115-c may transmit the second SRS 415 and the third SRS 420 without one or more guard symbols between them. Such an arrangement may be possible since the UE 115-c may employ more than 2 active transmission chains.

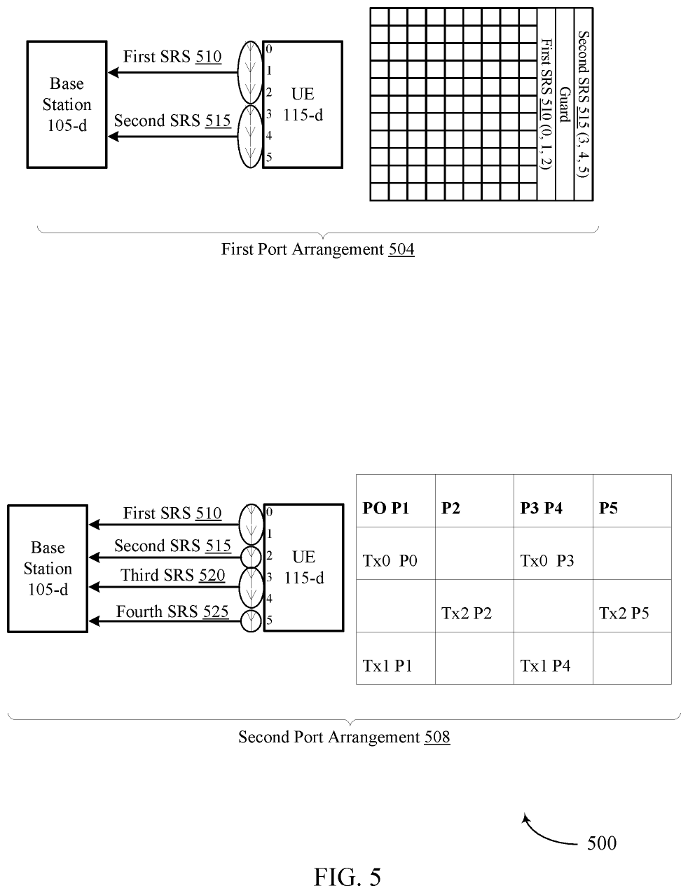

FIG. 5 illustrates examples of SRS transmission scheme 500 that supports reference signal designs in accordance with examples as disclosed herein. The SRS transmission scheme 500 may include a first port arrangement 504 and a second port arrangement 508. Though particular examples of port arrangements, SRS resources, SRS transmissions, ports, guard symbols, and other elements are shown in these examples, other combinations are possible and are contemplated by the subject matter disclosed herein.

In the first port arrangement 504, the UE 115-d may transmit the first SRS 510 and the second SRS 515 to the base station 105-d using two SRS resources that may use six transmit antenna ports (e.g., 0, 1, 2, 3, 4, and 5) and the two SRS resources may be separated by one or more guard symbols (e.g., as depicted). The first SRS 510 may be associated with or transmitted using three antenna ports (e.g., 0, 1, and 2) and the second SRS 515 may be associated with or transmitted using three antenna ports (e.g., 3, 4, and 5).

The first port arrangement 504 may include or be associated with two SRS resources mapped to a single resource set. Additionally or alternatively, a first SRS resource set may include a single resource associated with three antenna ports and the second SRS resource set may include a single resource associated with a single port. In some examples involving periodic/semi-persistent SRS, a single SRS resource set may include or be associated with two SRS resources. Further, the base station 105-d may configure one or more resource sets for situations involving periodic/semi-persistent SRS. Further, in some examples, the UE 115-d may transmit two resources simultaneously in different resource elements (e.g., which may involve the use of frequency domain multiplexing).

In the second port arrangement 508, the UE 115-d may transmit the first SRS 510, the second SRS 515, the third SRS 520, and the fourth SRS 525 to the base station 105-d using four SRS resources that may use six transmit antenna ports (e.g., 0, 1, 2, 3, 4, and 5) and the four SRS resources may not be separated by one or more guard symbols. The elimination of the guard symbols may be made possible by a transmission scheme (e.g., as depicted in FIG. 5).

In some examples involving periodic/semi-persistent SRS, a single SRS resource set may include or be associated with two, three, or four SRS resources. For example, the single SRS resource set may include or be associated with resources for the first SRS 510, the second SRS 515, the third SRS 520, and the fourth SRS 525. Further, the base station 105-d may configure one or more resource sets for situations involving periodic/semi-persistent SRS.

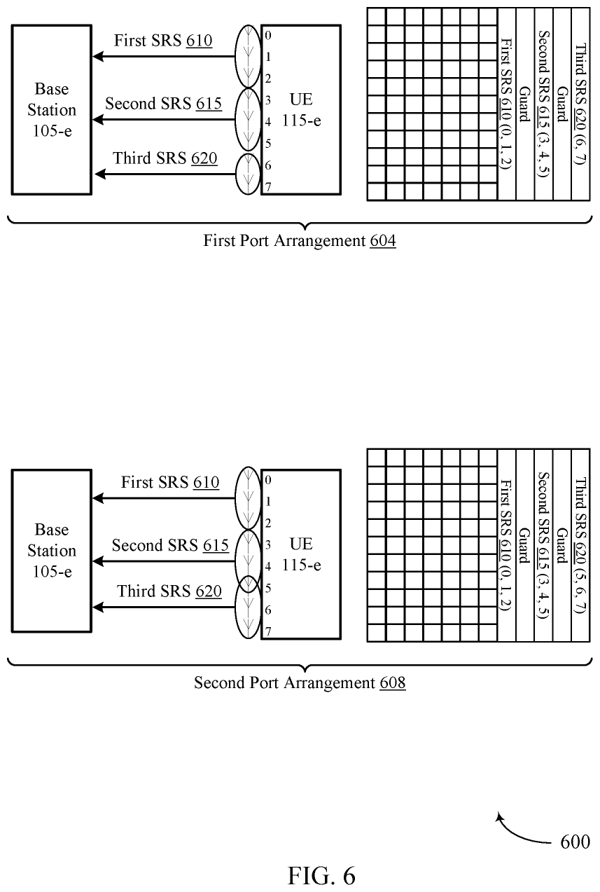

FIG. 6 illustrates examples of SRS transmission scheme 600 that supports reference signal designs in accordance with examples as disclosed herein. The SRS transmission scheme 600 may include a first port arrangement 604 and a second port arrangement 608. Though particular examples of port arrangements, SRS resources, SRS transmissions, ports, guard symbols, and other elements are shown in these examples, other combinations are possible and are contemplated by the subject matter disclosed herein.

In the first port arrangement 604, the UE 115-e may transmit the first SRS 610, the second SRS 615, and the third SRS 620 to the base station 105-e using three SRS resources that may use eight transmit antenna ports (e.g., 0, 1, 2, 3, 4, 5, 6, and 7) and the three SRS resources may be separated by one or more guard symbols (e.g., as depicted). The first SRS 610 may be associated with or transmitted using three antenna ports (e.g., 0, 1, and 2), the second SRS 615 may be associated with or transmitted using three antenna ports (e.g., 3, 4, and 5), and the third SRS 620 may be associated with or transmitted using two antenna ports (e.g., 6 and 7).

The first port arrangement 604 may include or be associated with three SRS resources mapped to a single resource set. Additionally or alternatively, a first SRS resource set may include a single resource and a second SRS resource set may include two resources. Additionally or alternatively, a first SRS resource set, and second SRS resource set, and a third SRS resource set may each include one resource.

In some examples, a transmission power of one or more ports may be different than a transmission power of one or more other ports. For example, the transmission power of the first SRS 610 may be different from the transmission power of the second SRS 615 which may also be different from the transmission power of the third SRS 620. This may cause the SRS channel estimation accuracy for one or more ports to vary accordingly.

In the second port arrangement 608, the UE 115-e may transmit the first SRS 610, the second SRS 615, and the third SRS 620 to the base station 105-e using three SRS resources that may use eight transmit antenna ports (e.g., 0, 1, 2, 3, 4, 5, 6, and 7) and the three SRS resources may be separated by one or more guard symbols (e.g., as depicted). The first SRS 610 may be associated with or transmitted using three antenna ports (e.g., 0, 1, and 2), the second SRS 615 may be associated with or transmitted using three antenna ports (e.g., 3, 4, and 5), and the third SRS 620 may be associated with or transmitted using three antenna ports (e.g., 5, 6 and 7). In some examples, multiple SRS resources associated with respective SRSs may overlap in terms of the antenna ports associated with the SRS resources. For example, and as depicted in FIG. 6, the second SRS 615 may be transmitted using antenna ports 3, 4, and 5, and the third SRS 620 may be transmitted using antenna ports 5, 6, and 7, thereby “sharing” antenna port 5 with both the second SRS 615 (and its associated resource) and the third SRS 620 (and its associated resource). This may cause the SRS channel estimation accuracy for one or more ports to vary accordingly.

The first port arrangement 604 may include or be associated with three SRS resources mapped to a single resource set. Additionally or alternatively, a first SRS resource set may include a single resource and a second SRS resource set may include two resources. Additionally or alternatively, a first SRS resource set, and second SRS resource set, and a third SRS resource set may each include one resource.

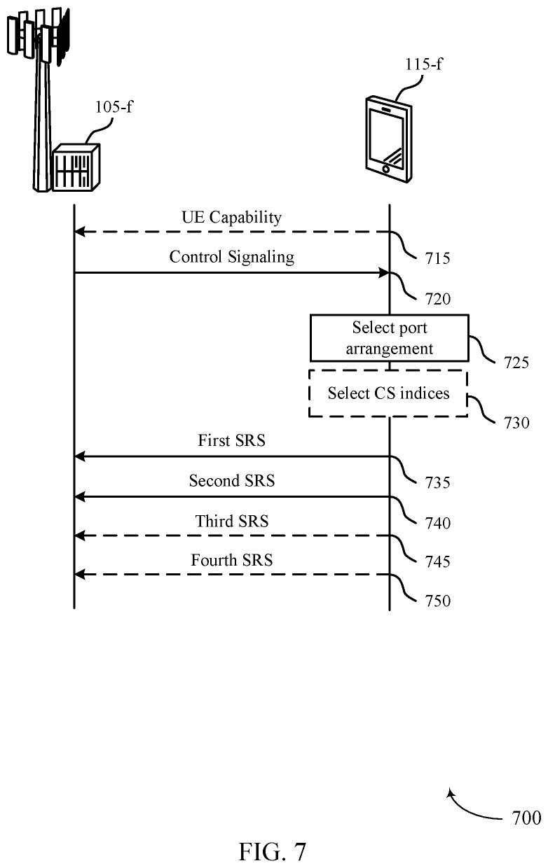

FIG. 7 illustrates an example of a process flow 700 that supports reference signal designs in accordance with examples as disclosed herein. FIG. 7 illustrates an example of a process flow 700 for wireless communications systems in accordance with one or more aspects of the present disclosure. The process flow 700 may implement various aspects of the present disclosure described with reference to FIGS. 1-6. The process flow 700 may include a UE 115-f and a base station 105-f, which may be examples of UE 115 and base station 105 as described with reference to FIGS. 1-7. In some examples, the UE 115-f may be configured with a one or more parameters for transmitting multiple SRSs using multiple ports on a user equipment.

In the following description of the process flow 700, the operations between the UE 115-f and the base station 105-f may be performed in different orders or at different times. Some operations may also be left out of the process flow 700, or other operations may be added. Although the UE 115-f and the base station 105-f are shown performing the operations of the process flow 700, some aspects of some operations may also be performed by the base station 105-f, the UE 115-f, one or more other wireless devices, or any combination thereof.

At 715, the UE 115-f may transmit a first indication of a port arrangement capability of the UE. In some examples, the port arrangement capability may include a second indication of the first quantity of ports.

At 720, the UE 115-f may receive, from base station 105-f, control signaling indicating a plurality of port arrangements for transmitting one or more sounding reference signals to the base station.

At 725, the UE 115-f may select a port arrangement of the plurality of port arrangements based on a first quantity of ports available to the UE for transmitting the one or more sounding reference signals. In some examples, the UE 115-f may map the second quantity of ports to a first pattern of frequency resources for communicating sounding reference signals. In some examples, the UE 115-f may calculate a cyclic shift for each port of the second quantity of ports. In some examples, the UE 115-f may map the third quantity of ports to a second pattern of frequency resources for communicating the sounding reference signals. In some examples, the UE 115-f may calculate a cyclic shift for each port of the third quantity of ports.

In some examples, the UE 115-f may map a first portion of the second quantity of ports to a first pattern of frequency resources for communicating sounding reference signals and a second portion of the second quantity of ports to a second pattern of frequency resources for communicating the sounding reference signals. In some examples, the UE 115-f may calculate a cyclic shift for each port of the second quantity of ports. In some examples, the UE 115-f may map a first portion of the third quantity of ports to a third pattern of frequency resources for communicating the sounding reference signals and a second portion of the third quantity of ports to a fourth pattern of frequency resources for communicating the sounding reference signals. In some examples, the UE 115-f may calculate a cyclic shift for each port of the third quantity of ports.

In some examples, the UE 115-f may identify the first quantity of ports available to the UE for transmitting the one or more sounding reference signals. In some examples, selecting the port arrangement may be based on identifying the first quantity of ports.

In some examples, the second quantity of ports and the third quantity of ports may be a same quantity. In some examples, the second quantity of ports and the third quantity of ports may be different quantities. In some examples, one or more ports of the second quantity of ports may be included in the third quantity of ports.

At 730, the UE 115-f may select one or more cyclic shift indices. In some examples, the UE 115-f may select the one or more cyclic shift indices based on a rounding function applied to one or more cyclic shift parameters. In some examples, the UE 115-f may select the one or more cyclic shift indices based on a floor function applied to one or more cyclic shift parameters. In some examples, the UE 115-f may select the one or more cyclic shift indices based on a ceiling function applied to one or more cyclic shift parameters. In some examples, the one or more cyclic shift parameters may include a quantity of ports, a quantity of sounding reference signal resource sets, an upper limit for a quantity of sounding reference signal resources sets, a port index, or any combination thereof. In some examples, transmitting the first sounding reference signal and the second sounding reference signal may be based on the selected one or more cyclic shift indices.

At 735, the UE 115-f may transmit a first sounding reference signal using a second quantity of ports of the first quantity of ports based on the selected port arrangement. In some examples, the UE 115-f may transmit the first sounding reference signal in a first time resource. In some examples, the first time resource and the second time resource may be separated by a third time resource. In some examples, the first time resource and the second time resource may be contiguous.

At 740, the UE 115-f may transmit a second sounding reference signal using a third quantity of ports of the first quantity of ports based on the selected port arrangement. In some examples, the UE 115-f may transmit the second sounding reference signal in a second time resource. In some examples, the first time resource and the second time resource may be separated by a third time resource. In some examples, the first time resource and the second time resource may be contiguous.

At 745, the UE 115-f may transmit a third sounding reference signal using a fourth quantity of ports of the first quantity of ports based on the selected port arrangement.

At 750, the UE 115-f may transmit a fourth sounding reference signal using a fifth quantity of ports of the first quantity of ports based on the selected port arrangement.

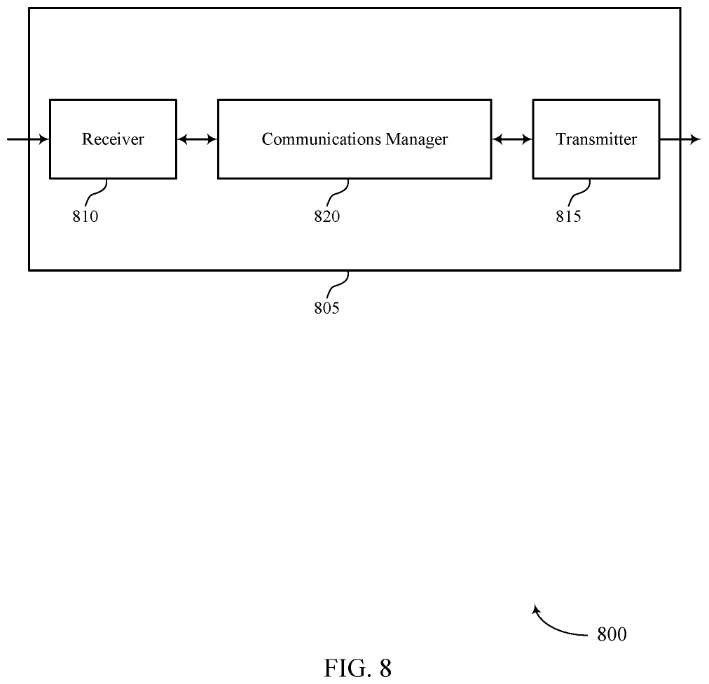

FIG. 8 shows a block diagram 800 of a device 805 that supports reference signal designs in accordance with examples as disclosed herein. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to reference signal designs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reference signal designs). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of reference signal designs as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

Additionally or alternatively, the communications manager 820 may support wireless communications at a UE in accordance with examples as disclosed herein. For example, the communications manager 820 may be configured as or otherwise support a means for receiving, from a base station, control signaling indicating a set of multiple port arrangements for transmitting one or more sounding reference signals to the base station. The communications manager 820 may be configured as or otherwise support a means for selecting a port arrangement of the set of multiple port arrangements based on a first quantity of ports available to the UE for transmitting the one or more sounding reference signals. The communications manager 820 may be configured as or otherwise support a means for transmitting a first sounding reference signal using a second quantity of ports of the first quantity of ports based on the selected port arrangement. The communications manager 820 may be configured as or otherwise support a means for transmitting a second sounding reference signal using a third quantity of ports of the first quantity of ports based on the selected port arrangement.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, more efficient utilization of communication resources, or a combination thereof.

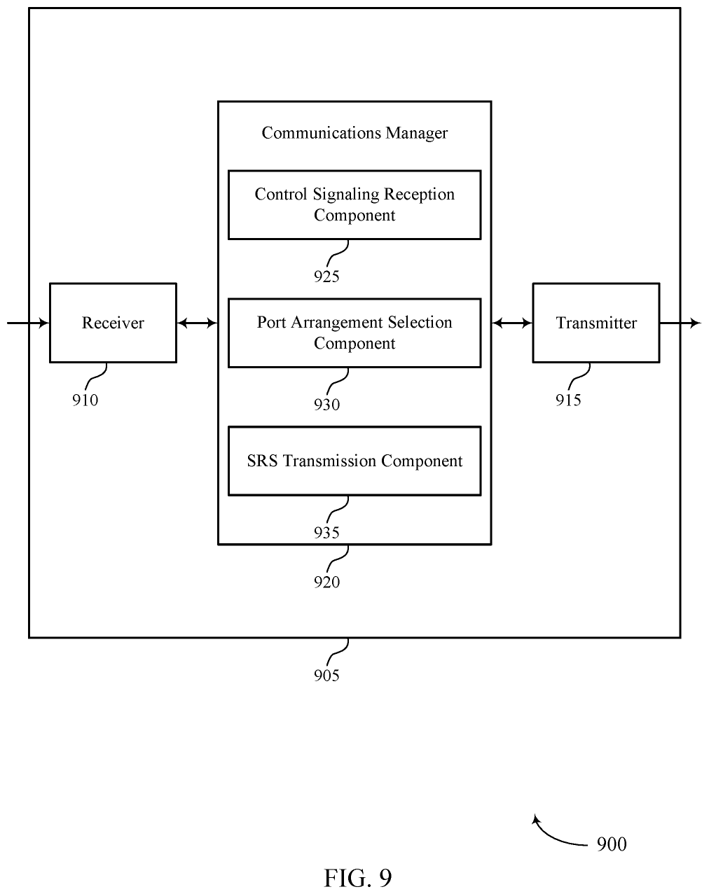

FIG. 9 shows a block diagram 900 of a device 905 that supports reference signal designs in accordance with examples as disclosed herein. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to reference signal designs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to reference signal designs). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of reference signal designs as described herein. For example, the communications manager 920 may include a control signaling reception component 925, a port arrangement selection component 930, an SRS transmission component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. The control signaling reception component 925 may be configured as or otherwise support a means for receiving, from a base station, control signaling indicating a set of multiple port arrangements for transmitting one or more sounding reference signals to the base station. The port arrangement selection component 930 may be configured as or otherwise support a means for selecting a port arrangement of the set of multiple port arrangements based on a first quantity of ports available to the UE for transmitting the one or more sounding reference signals. The SRS transmission component 935 may be configured as or otherwise support a means for transmitting a first sounding reference signal using a second quantity of ports of the first quantity of ports based on the selected port arrangement. The SRS transmission component 935 may be configured as or otherwise support a means for transmitting a second sounding reference signal using a third quantity of ports of the first quantity of ports based on the selected port arrangement.

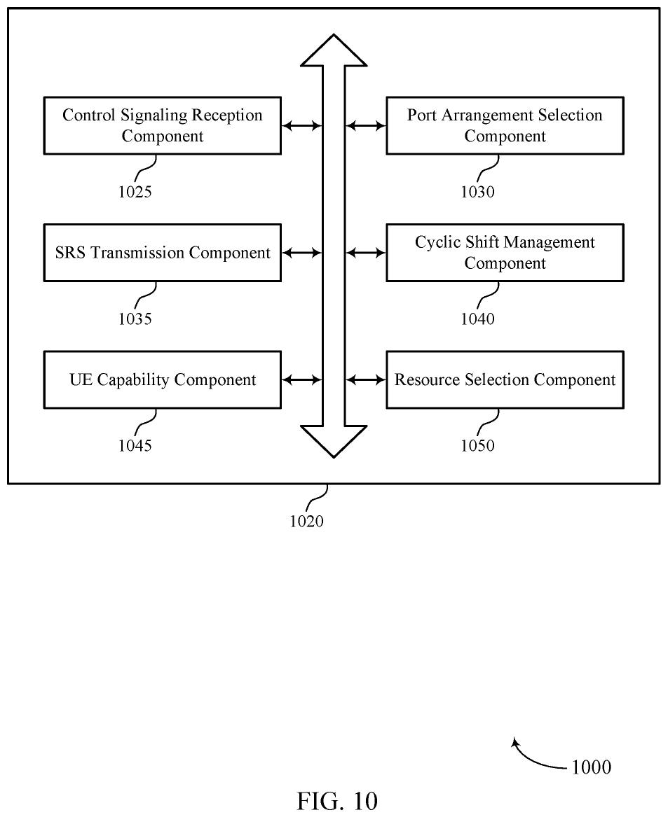

FIG. 10 shows a block diagram 1000 of a communications manager 1020 that supports reference signal designs in accordance with examples as disclosed herein. The communications manager 1020 may be an example of aspects of a communications manager 820, a communications manager 920, or both, as described herein. The communications manager 1020, or various components thereof, may be an example of means for performing various aspects of reference signal designs as described herein. For example, the communications manager 1020 may include a control signaling reception component 1025, a port arrangement selection component 1030, an SRS transmission component 1035, a cyclic shift management component 1040, a UE capability component 1045, a resource selection component 1050, or any combination thereof. Each of these components may communicate, directly or indirectly, with one another (e.g., via one or more buses).

Additionally or alternatively, the communications manager 1020 may support wireless communications at a UE in accordance with examples as disclosed herein. The control signaling reception component 1025 may be configured as or otherwise support a means for receiving, from a base station, control signaling indicating a set of multiple port arrangements for transmitting one or more sounding reference signals to the base station. The port arrangement selection component 1030 may be configured as or otherwise support a means for selecting a port arrangement of the set of multiple port arrangements based on a first quantity of ports available to the UE for transmitting the one or more sounding reference signals. The SRS transmission component 1035 may be configured as or otherwise support a means for transmitting a first sounding reference signal using a second quantity of ports of the first quantity of ports based on the selected port arrangement. In some examples, the SRS transmission component 1035 may be configured as or otherwise support a means for transmitting a second sounding reference signal using a third quantity of ports of the first quantity of ports based on the selected port arrangement.

In some examples, the SRS transmission component 1035 may be configured as or otherwise support a means for transmitting a third sounding reference signal using a fourth quantity of ports of the first quantity of ports based on the selected port arrangement.

In some examples, the SRS transmission component 1035 may be configured as or otherwise support a means for transmitting a fourth sounding reference signal using a fifth quantity of ports of the first quantity of ports based on the selected port arrangement.

In some examples, the SRS transmission component 1035 may be configured as or otherwise support a means for transmitting the first sounding reference signal in a first time resource and the second sounding reference signal in a second time resource, where the first time resource and the second time resource are separated by a third time resource.

In some examples, the SRS transmission component 1035 may be configured as or otherwise support a means for transmitting the first sounding reference signal in a first time resource and the second sounding reference signal in a second time resource, where the first time resource and the second time resource are contiguous.

In some examples, the cyclic shift management component 1040 may be configured as or otherwise support a means for selecting one or more cyclic shift indices based on a rounding function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal is based on the selected one or more cyclic shift indices.

In some examples, the cyclic shift management component 1040 may be configured as or otherwise support a means for selecting one or more cyclic shift indices based on a floor function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal is based on the selected one or more cyclic shift indices.

In some examples, the cyclic shift management component 1040 may be configured as or otherwise support a means for selecting one or more cyclic shift indices based on a ceiling function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal is based on the selected one or more cyclic shift indices.

In some examples, the UE capability component 1045 may be configured as or otherwise support a means for transmitting a first indication of a port arrangement capability of the UE, where the port arrangement capability includes a second indication of the first quantity of ports.

In some examples, the resource selection component 1050 may be configured as or otherwise support a means for mapping the second quantity of ports to a first pattern of frequency resources for communicating sounding reference signals. In some examples, the cyclic shift management component 1040 may be configured as or otherwise support a means for calculating a cyclic shift for each port of the second quantity of ports. In some examples, the resource selection component 1050 may be configured as or otherwise support a means for mapping the third quantity of ports to a second pattern of frequency resources for communicating the sounding reference signals. In some examples, the cyclic shift management component 1040 may be configured as or otherwise support a means for calculating a cyclic shift for each port of the third quantity of ports.

In some examples, the resource selection component 1050 may be configured as or otherwise support a means for mapping a first portion of the second quantity of ports to a first pattern of frequency resources for communicating sounding reference signals and a second portion of the second quantity of ports to a second pattern of frequency resources for communicating the sounding reference signals. In some examples, the cyclic shift management component 1040 may be configured as or otherwise support a means for calculating a cyclic shift for each port of the second quantity of ports. In some examples, the resource selection component 1050 may be configured as or otherwise support a means for mapping a first portion of the third quantity of ports to a third pattern of frequency resources for communicating the sounding reference signals and a second portion of the third quantity of ports to a fourth pattern of frequency resources for communicating the sounding reference signals. In some examples, the cyclic shift management component 1040 may be configured as or otherwise support a means for calculating a cyclic shift for each port of the third quantity of ports.

In some examples, the port arrangement selection component 1030 may be configured as or otherwise support a means for identifying the first quantity of ports available to the UE for transmitting the one or more sounding reference signals, where selecting the port arrangement is based on identifying the first quantity of ports.

In some examples, the second quantity of ports and the third quantity of ports are a same quantity. In some examples, the second quantity of ports and the third quantity of ports are different quantities. In some examples, one or more ports of the second quantity of ports are also included in the third quantity of ports.

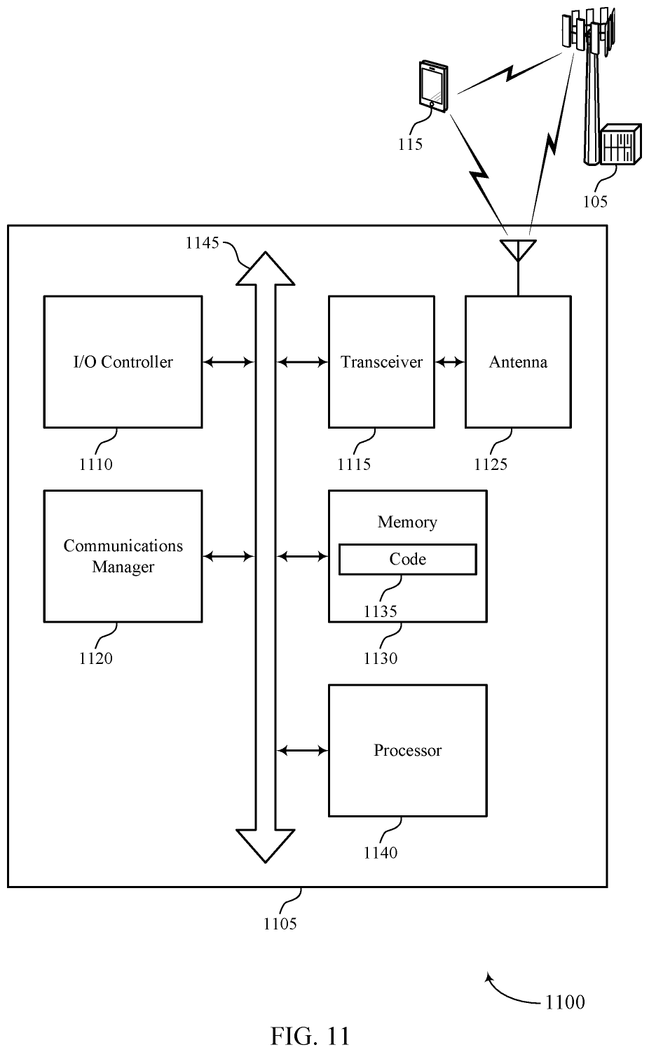

FIG. 11 shows a diagram of a system 1100 including a device 1105 that supports reference signal designs in accordance with examples as disclosed herein. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting reference signal designs). For example, the device 1105 or a component of the device 1105 may include a processor 1140 and memory 1130 coupled to the processor 1140, the processor 1140 and memory 1130 configured to perform various functions described herein.

Additionally or alternatively, the communications manager 1120 may support wireless communications at a UE in accordance with examples as disclosed herein. For example, the communications manager 1120 may be configured as or otherwise support a means for receiving, from a base station, control signaling indicating a set of multiple port arrangements for transmitting one or more sounding reference signals to the base station. The communications manager 1120 may be configured as or otherwise support a means for selecting a port arrangement of the set of multiple port arrangements based on a first quantity of ports available to the UE for transmitting the one or more sounding reference signals. The communications manager 1120 may be configured as or otherwise support a means for transmitting a first sounding reference signal using a second quantity of ports of the first quantity of ports based on the selected port arrangement. The communications manager 1120 may be configured as or otherwise support a means for transmitting a second sounding reference signal using a third quantity of ports of the first quantity of ports based on the selected port arrangement.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of reference signal designs as described herein, or the processor 1140 and the memory 1130 may be otherwise configured to perform or support such operations.

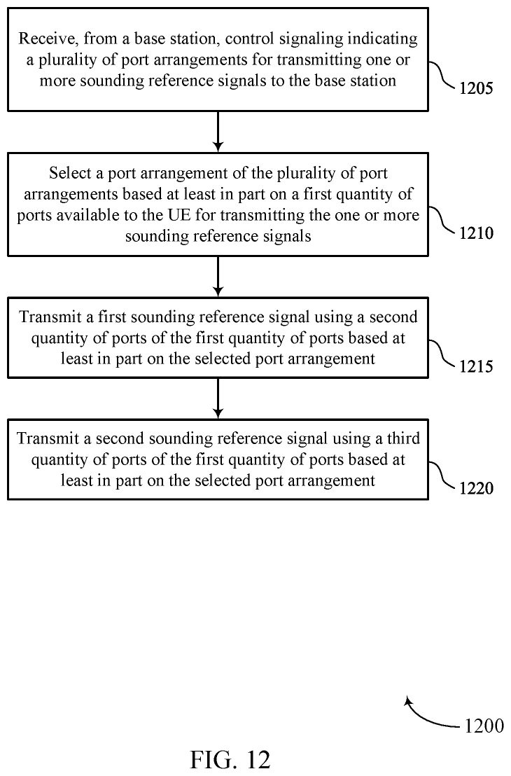

FIG. 12 shows a flowchart illustrating a method 1200 that supports reference signal designs in accordance with examples as disclosed herein. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, control signaling indicating a set of multiple port arrangements for transmitting one or more sounding reference signals to the base station. The operations of 1205 may be performed in accordance with examples as disclosed herein. In some examples, aspects of the operations of 1205 may be performed by a control signaling reception component 1025 as described with reference to FIG. 10.

At 1210, the method may include selecting a port arrangement of the set of multiple port arrangements based on a first quantity of ports available to the UE for transmitting the one or more sounding reference signals. The operations of 1210 may be performed in accordance with examples as disclosed herein. In some examples, aspects of the operations of 1210 may be performed by a port arrangement selection component 1030 as described with reference to FIG. 10.

At 1215, the method may include transmitting a first sounding reference signal using a second quantity of ports of the first quantity of ports based on the selected port arrangement. The operations of 1215 may be performed in accordance with examples as disclosed herein. In some examples, aspects of the operations of 1215 may be performed by an SRS transmission component 1035 as described with reference to FIG. 10.

At 1220, the method may include transmitting a second sounding reference signal using a third quantity of ports of the first quantity of ports based on the selected port arrangement. The operations of 1220 may be performed in accordance with examples as disclosed herein. In some examples, aspects of the operations of 1220 may be performed by an SRS transmission component 1035 as described with reference to FIG. 10.

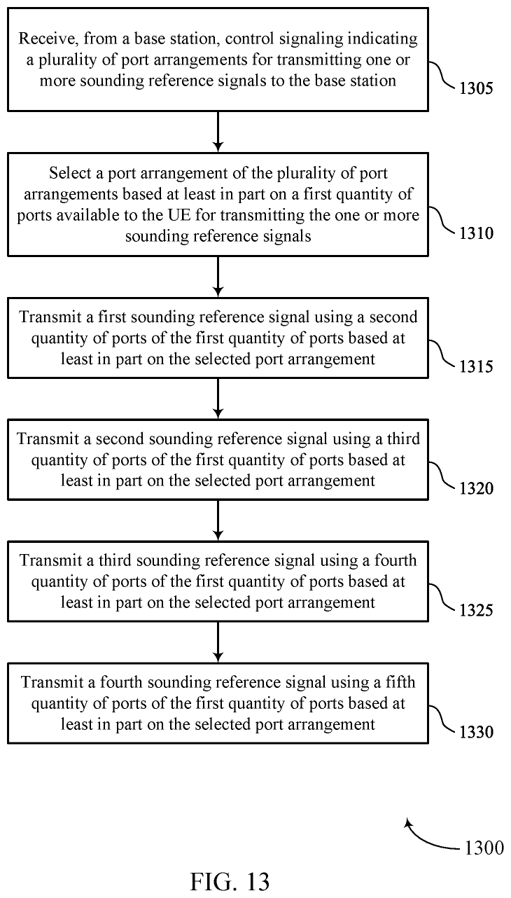

FIG. 13 shows a flowchart illustrating a method 1300 that supports reference signal designs in accordance with examples as disclosed herein. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, control signaling indicating a set of multiple port arrangements for transmitting one or more sounding reference signals to the base station. The operations of 1305 may be performed in accordance with examples as disclosed herein. In some examples, aspects of the operations of 1305 may be performed by a control signaling reception component 1025 as described with reference to FIG. 10.

At 1310, the method may include selecting a port arrangement of the set of multiple port arrangements based on a first quantity of ports available to the UE for transmitting the one or more sounding reference signals. The operations of 1310 may be performed in accordance with examples as disclosed herein. In some examples, aspects of the operations of 1310 may be performed by a port arrangement selection component 1030 as described with reference to FIG. 10.

At 1315, the method may include transmitting a first sounding reference signal using a second quantity of ports of the first quantity of ports based on the selected port arrangement. The operations of 1315 may be performed in accordance with examples as disclosed herein. In some examples, aspects of the operations of 1315 may be performed by an SRS transmission component 1035 as described with reference to FIG. 10.

At 1320, the method may include transmitting a second sounding reference signal using a third quantity of ports of the first quantity of ports based on the selected port arrangement. The operations of 1320 may be performed in accordance with examples as disclosed herein. In some examples, aspects of the operations of 1320 may be performed by an SRS transmission component 1035 as described with reference to FIG. 10.

At 1325, the method may include transmitting a third sounding reference signal using a fourth quantity of ports of the first quantity of ports based on the selected port arrangement. The operations of 1325 may be performed in accordance with examples as disclosed herein. In some examples, aspects of the operations of 1325 may be performed by an SRS transmission component 1035 as described with reference to FIG. 10.

At 1330, the method may include transmitting a fourth sounding reference signal using a fifth quantity of ports of the first quantity of ports based on the selected port arrangement. The operations of 1330 may be performed in accordance with examples as disclosed herein. In some examples, aspects of the operations of 1330 may be performed by an SRS transmission component 1035 as described with reference to FIG. 10.

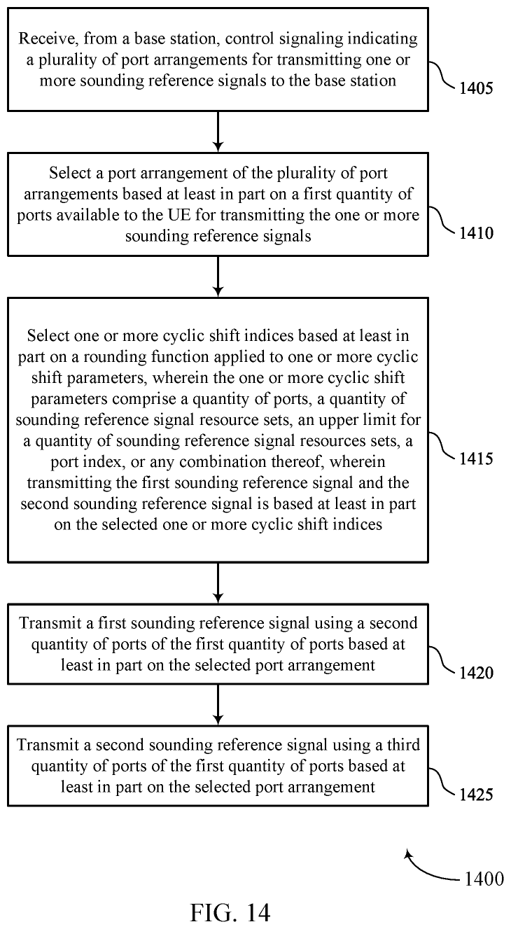

FIG. 14 shows a flowchart illustrating a method 1400 that supports reference signal designs in accordance with examples as disclosed herein. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a set of multiple port arrangements for transmitting one or more sounding reference signals to the base station. The operations of 1405 may be performed in accordance with examples as disclosed herein. In some examples, aspects of the operations of 1405 may be performed by a control signaling reception component 1025 as described with reference to FIG. 10.

At 1410, the method may include selecting a port arrangement of the set of multiple port arrangements based on a first quantity of ports available to the UE for transmitting the one or more sounding reference signals. The operations of 1410 may be performed in accordance with examples as disclosed herein. In some examples, aspects of the operations of 1410 may be performed by a port arrangement selection component 1030 as described with reference to FIG. 10.

At 1415, the method may include selecting one or more cyclic shift indices based on a rounding function applied to one or more cyclic shift parameters, where the one or more cyclic shift parameters include a quantity of ports, a quantity of sounding reference signal resource sets, an upper limit for a quantity of sounding reference signal resources sets, a port index, or any combination thereof, where transmitting the first sounding reference signal and the second sounding reference signal is based on the selected one or more cyclic shift indices. The operations of 1415 may be performed in accordance with examples as disclosed herein. In some examples, aspects of the operations of 1415 may be performed by a cyclic shift management component 1040 as described with reference to FIG. 10.

At 1420, the method may include transmitting a first sounding reference signal using a second quantity of ports of the first quantity of ports based on the selected port arrangement. The operations of 1420 may be performed in accordance with examples as disclosed herein. In some examples, aspects of the operations of 1420 may be performed by an SRS transmission component 1035 as described with reference to FIG. 10.

At 1425, the method may include transmitting a second sounding reference signal using a third quantity of ports of the first quantity of ports based on the selected port arrangement. The operations of 1425 may be performed in accordance with examples as disclosed herein. In some examples, aspects of the operations of 1425 may be performed by an SRS transmission component 1035 as described with reference to FIG. 10.

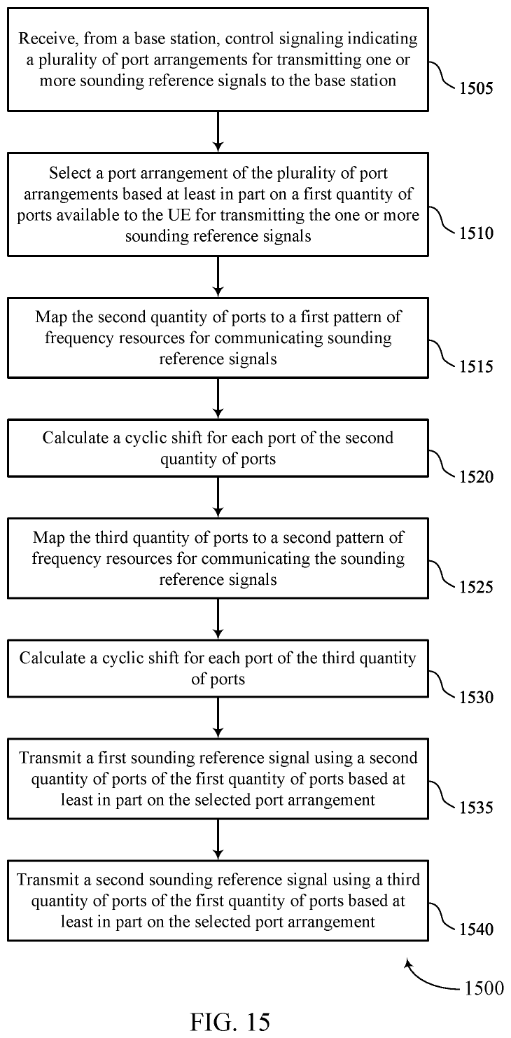

FIG. 15 shows a flowchart illustrating a method 1500 that supports reference signal designs in accordance with examples as disclosed herein. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling indicating a set of multiple port arrangements for transmitting one or more sounding reference signals to the base station. The operations of 1505 may be performed in accordance with examples as disclosed herein. In some examples, aspects of the operations of 1505 may be performed by a control signaling reception component 1025 as described with reference to FIG. 10.

At 1510, the method may include selecting a port arrangement of the set of multiple port arrangements based on a first quantity of ports available to the UE for transmitting the one or more sounding reference signals. The operations of 1510 may be performed in accordance with examples as disclosed herein. In some examples, aspects of the operations of 1510 may be performed by a port arrangement selection component 1030 as described with reference to FIG. 10.

At 1515, the method may include mapping the second quantity of ports to a first pattern of frequency resources for communicating sounding reference signals. The operations of 1515 may be performed in accordance with examples as disclosed herein. In some examples, aspects of the operations of 1515 may be performed by a resource selection component 1050 as described with reference to FIG. 10.

At 1520, the method may include calculating a cyclic shift for each port of the second quantity of ports. The operations of 1520 may be performed in accordance with examples as disclosed herein. In some examples, aspects of the operations of 1520 may be performed by a cyclic shift management component 1040 as described with reference to FIG. 10.

At 1525, the method may include mapping the third quantity of ports to a second pattern of frequency resources for communicating the sounding reference signals. The operations of 1525 may be performed in accordance with examples as disclosed herein. In some examples, aspects of the operations of 1525 may be performed by a resource selection component 1050 as described with reference to FIG. 10.

At 1530, the method may include calculating a cyclic shift for each port of the third quantity of ports. The operations of 1530 may be performed in accordance with examples as disclosed herein. In some examples, aspects of the operations of 1530 may be performed by a cyclic shift management component 1040 as described with reference to FIG. 10.

At 1535, the method may include transmitting a first sounding reference signal using a second quantity of ports of the first quantity of ports based on the selected port arrangement. The operations of 1535 may be performed in accordance with examples as disclosed herein. In some examples, aspects of the operations of 1535 may be performed by an SRS transmission component 1035 as described with reference to FIG. 10.

At 1540, the method may include transmitting a second sounding reference signal using a third quantity of ports of the first quantity of ports based on the selected port arrangement. The operations of 1540 may be performed in accordance with examples as disclosed herein. In some examples, aspects of the operations of 1540 may be performed by an SRS transmission component 1035 as described with reference to FIG. 10.

The following provides an overview of aspects of the present disclosure:

Aspect 1: A method for wireless communications at a UE, comprising: receiving, from a base station, control signaling indicating a plurality of port arrangements for transmitting one or more sounding reference signals to the base station; selecting a port arrangement of the plurality of port arrangements based at least in part on a first quantity of ports available to the UE for transmitting the one or more sounding reference signals; transmitting a first sounding reference signal using a second quantity of ports of the first quantity of ports based at least in part on the selected port arrangement; and transmitting a second sounding reference signal using a third quantity of ports of the first quantity of ports based at least in part on the selected port arrangement.

Aspect 2: The method of aspect 1, further comprising: transmitting a third sounding reference signal using a fourth quantity of ports of the first quantity of ports based at least in part on the selected port arrangement.

Aspect 3: The method of aspect 2, further comprising: transmitting a fourth sounding reference signal using a fifth quantity of ports of the first quantity of ports based at least in part on the selected port arrangement.

Aspect 4: The method of any of aspects 1 through 3, further comprising: transmitting the first sounding reference signal in a first time resource and the second sounding reference signal in a second time resource, wherein the first time resource and the second time resource are separated by a third time resource.

Aspect 5: The method of any of aspects 1 through 4, further comprising: transmitting the first sounding reference signal in a first time resource and the second sounding reference signal in a second time resource, wherein the first time resource and the second time resource are contiguous.

Aspect 6: The method of any of aspects 1 through 5, further comprising: selecting one or more cyclic shift indices based at least in part on a rounding function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

Aspect 7: The method of any of aspects 1 through 6, further comprising: selecting one or more cyclic shift indices based at least in part on a floor function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

Aspect 8: The method of any of aspects 1 through 7, further comprising: selecting one or more cyclic shift indices based at least in part on a ceiling function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

Aspect 9: The method of any of aspects 1 through 8, further comprising: transmitting a first indication of a port arrangement capability of the UE, wherein the port arrangement capability includes a second indication of the first quantity of ports.

Aspect 10: The method of any of aspects 1 through 9, further comprising: mapping the second quantity of ports to a first pattern of frequency resources for communicating sounding reference signals; calculating a cyclic shift for each port of the second quantity of ports; mapping the third quantity of ports to a second pattern of frequency resources for communicating the sounding reference signals; and calculating a cyclic shift for each port of the third quantity of ports.

Aspect 11: The method of any of aspects 1 through 10, further comprising: mapping a first portion of the second quantity of ports to a first pattern of frequency resources for communicating sounding reference signals and a second portion of the second quantity of ports to a second pattern of frequency resources for communicating the sounding reference signals; calculating a cyclic shift for each port of the second quantity of ports; mapping a first portion of the third quantity of ports to a third pattern of frequency resources for communicating the sounding reference signals and a second portion of the third quantity of ports to a fourth pattern of frequency resources for communicating the sounding reference signals; and calculating a cyclic shift for each port of the third quantity of ports.

Aspect 12: The method of any of aspects 1 through 11, further comprising: identifying the first quantity of ports available to the UE for transmitting the one or more sounding reference signals, wherein selecting the port arrangement is based at least in part on identifying the first quantity of ports.

Aspect 13: The method of any of aspects 1 through 12, wherein the second quantity of ports and the third quantity of ports are a same quantity.

Aspect 14: The method of any of aspects 1 through 13, wherein the second quantity of ports and the third quantity of ports are different quantities.

Aspect 15: The method of any of aspects 1 through 14, wherein one or more ports of the second quantity of ports are also comprised in the third quantity of ports.

Aspect 16: An apparatus for wireless communications at a UE, comprising a processor; memory coupled with the processor; and instructions stored in the memory and executable by the processor to cause the apparatus to perform a method of any of aspects 1 through 15.

Aspect 17: An apparatus for wireless communications at a UE, comprising at least one means for performing a method of any of aspects 1 through 15.

Aspect 18: A non-transitory computer-readable medium storing code for wireless communications at a UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a memory; and
a processor coupled to the memory and configured to cause the apparatus to:
receive, from a base station, control signaling indicating a plurality of port arrangements for transmitting one or more sounding reference signals to the base station;
select a port arrangement of the plurality of port arrangements based at least in part on a first quantity of ports available to the UE for transmitting the one or more sounding reference signals;
transmit a first sounding reference signal using a second quantity of ports of the first quantity of ports based at least in part on the selected port arrangement; and
transmit a second sounding reference signal using a third quantity of ports of the first quantity of ports based at least in part on the selected port arrangement.

2. The apparatus of claim 1, wherein the processor is further configured to cause the apparatus to transmit a third sounding reference signal using a fourth quantity of ports of the first quantity of ports based at least in part on the selected port arrangement.

3. The apparatus of claim 2, wherein the processor is further configured to cause the apparatus to transmit a fourth sounding reference signal using a fifth quantity of ports of the first quantity of ports based at least in part on the selected port arrangement.

4. The apparatus of claim 1, wherein the processor is further configured to cause the apparatus to transmit the first sounding reference signal in a first time resource and the second sounding reference signal in a second time resource, wherein the first time resource and the second time resource are separated by a third time resource.

5. The apparatus of claim 1, wherein the processor is further configured to cause the apparatus to transmit the first sounding reference signal in a first time resource and the second sounding reference signal in a second time resource, wherein the first time resource and the second time resource are contiguous.

6. The apparatus of claim 1, wherein the processor is further configured to cause the apparatus to select one or more cyclic shift indices based at least in part on a rounding function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

7. The apparatus of claim 1, wherein the processor is further configured to cause the apparatus to select one or more cyclic shift indices based at least in part on a floor function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

8. The apparatus of claim 1, wherein the processor is further configured to cause the apparatus to select one or more cyclic shift indices based at least in part on a ceiling function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

9. The apparatus of claim 1, wherein the processor is further configured to cause the apparatus to transmit a first indication of a port arrangement capability of the UE, wherein the port arrangement capability includes a second indication of the first quantity of ports.

10. The apparatus of claim 1, wherein the processor is further configured to cause the apparatus to:
map the second quantity of ports to a first pattern of frequency resources for communicating sounding reference signals;
calculate a cyclic shift for each port of the second quantity of ports;
map the third quantity of ports to a second pattern of frequency resources for communicating the sounding reference signals; and
calculate a cyclic shift for each port of the third quantity of ports.

11. The apparatus of claim 1, wherein the processor is further configured to cause the apparatus to:
map a first portion of the second quantity of ports to a first pattern of frequency resources for communicating sounding reference signals and a second portion of the second quantity of ports to a second pattern of frequency resources for communicating the sounding reference signals;
calculate a cyclic shift for each port of the second quantity of ports;
map a first portion of the third quantity of ports to a third pattern of frequency resources for communicating the sounding reference signals and a second portion of the third quantity of ports to a fourth pattern of frequency resources for communicating the sounding reference signals; and
calculate a cyclic shift for each port of the third quantity of ports.

12. The apparatus of claim 1, wherein the processor is further configured to cause the apparatus to identify the first quantity of ports available to the UE for transmitting the one or more sounding reference signals, wherein selecting the port arrangement is based at least in part on identifying the first quantity of ports.

13. The apparatus of claim 1, wherein the second quantity of ports and the third quantity of ports are a same quantity.

14. The apparatus of claim 1, wherein:
the second quantity of ports and the third quantity of ports are different quantities.

15. The apparatus of claim 1, wherein one or more ports of the second quantity of ports are also comprised in the third quantity of ports.

16. A method for wireless communications at a user equipment (UE), comprising:
receiving, from a base station, control signaling indicating a plurality of port arrangements for transmitting one or more sounding reference signals to the base station;
selecting a port arrangement of the plurality of port arrangements based at least in part on a first quantity of ports available to the UE for transmitting the one or more sounding reference signals;
transmitting a first sounding reference signal using a second quantity of ports of the first quantity of ports based at least in part on the selected port arrangement; and
transmitting a second sounding reference signal using a third quantity of ports of the first quantity of ports based at least in part on the selected port arrangement.

17. The method of claim 16, further comprising:
transmitting a third sounding reference signal using a fourth quantity of ports of the first quantity of ports based at least in part on the selected port arrangement.

18. The method of claim 17, further comprising:
transmitting a fourth sounding reference signal using a fifth quantity of ports of the first quantity of ports based at least in part on the selected port arrangement.

19. The method of claim 16, further comprising:
transmitting the first sounding reference signal in a first time resource and the second sounding reference signal in a second time resource, wherein the first time resource and the second time resource are separated by a third time resource.

20. The method of claim 16, further comprising:
transmitting the first sounding reference signal in a first time resource and the second sounding reference signal in a second time resource, wherein the first time resource and the second time resource are contiguous.

21. The method of claim 16, further comprising:
selecting one or more cyclic shift indices based at least in part on a rounding function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

22. The method of claim 16, further comprising:
selecting one or more cyclic shift indices based at least in part on a floor function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

23. The method of claim 16, further comprising:
selecting one or more cyclic shift indices based at least in part on a ceiling function applied to one or more cyclic shift parameters, wherein the one or more cyclic shift parameters comprise a quantity of ports, a quantity of sounding reference signal resource sets, an upper limit for a quantity of sounding reference signal resources sets, a port index, or any combination thereof, wherein transmitting the first sounding reference signal and the second sounding reference signal is based at least in part on the selected one or more cyclic shift indices.

24. The method of claim 16, further comprising:
transmitting a first indication of a port arrangement capability of the UE, wherein the port arrangement capability includes a second indication of the first quantity of ports.

25. The method of claim 16, further comprising:
mapping the second quantity of ports to a first pattern of frequency resources for communicating sounding reference signals;
calculating a cyclic shift for each port of the second quantity of ports;
mapping the third quantity of ports to a second pattern of frequency resources for communicating the sounding reference signals; and
calculating a cyclic shift for each port of the third quantity of ports.

26. The method of claim 16, further comprising:
mapping a first portion of the second quantity of ports to a first pattern of frequency resources for communicating sounding reference signals and a second portion of the second quantity of ports to a second pattern of frequency resources for communicating the sounding reference signals;
calculating a cyclic shift for each port of the second quantity of ports;
mapping a first portion of the third quantity of ports to a third pattern of frequency resources for communicating the sounding reference signals and a second portion of the third quantity of ports to a fourth pattern of frequency resources for communicating the sounding reference signals; and
calculating a cyclic shift for each port of the third quantity of ports.

27. The method of claim 16, further comprising:
identifying the first quantity of ports available to the UE for transmitting the one or more sounding reference signals, wherein selecting the port arrangement is based at least in part on identifying the first quantity of ports.

28. The method of claim 16, wherein the second quantity of ports and the third quantity of ports are different quantities.

29. An apparatus for wireless communications at a user equipment (UE), comprising:
means for receiving, from a base station, control signaling indicating a plurality of port arrangements for transmitting one or more sounding reference signals to the base station;
means for selecting a port arrangement of the plurality of port arrangements based at least in part on a first quantity of ports available to the UE for transmitting the one or more sounding reference signals;
means for transmitting a first sounding reference signal using a second quantity of ports of the first quantity of ports based at least in part on the selected port arrangement; and
means for transmitting a second sounding reference signal using a third quantity of ports of the first quantity of ports based at least in part on the selected port arrangement.

30. A non-transitory computer-readable medium storing code for wireless communications at a user equipment (UE), the code comprising instructions executable by a processor to:
receive, from a base station, control signaling indicating a plurality of port arrangements for transmitting one or more sounding reference signals to the base station;
select a port arrangement of the plurality of port arrangements based at least in part on a first quantity of ports available to the UE for transmitting the one or more sounding reference signals;
transmit a first sounding reference signal using a second quantity of ports of the first quantity of ports based at least in part on the selected port arrangement; and
transmit a second sounding reference signal using a third quantity of ports of the first quantity of ports based at least in part on the selected port arrangement.
